(19) United States
(12) Patent Application Publication
(10) Pub. No.: US 2003/0084301 A1
(43) Pub. Date: May 1, 2003

(54) System and method for secure data transmission

(76) Inventor: Neal A. Krawetz, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/999,122

(22) Filed: Oct. 30, 2001

(51) Int. Cl. H04L 9/00

(52) U.S. Cl. 713/184

(57) ABSTRACT

A system for secure data transmission comprises a memory accessible by a processor, an entry application stored in the memory and executable by the processor, and a padding application stored in the memory. The entry application is adapted to receive an identifier from a user. The padding application is adapted to automatically combine the identifier with padding data to form a padded identifier. The padded identifier is associated with accessing data at a recipient device.

### TECHNICAL FIELD OF THE INVENTION

The present invention relates generally to the field of data communications and, more particularly, to a system and method for secure data transmission.

### BACKGROUND OF THE INVENTION

Information, such as credit card account numbers, bank account numbers, automated teller machine (ATM) account numbers, personal information, and other types of confidential or sensitive information, is oftentimes stored on a remote server. To access the information, verify ownership of the information, or to authorize access or use of the information by a third party, a password, personal identification number (PIN), or other security measure is generally required. For example, in an ATM application, a PIN is generally provided by the holder of an ATM card in order to initiate a transaction related to the ATM card. The PIN is generally transmitted to the server and compared to a PIN stored at the server corresponding to the information. If the PINs match, access and use of the information stored on the server is granted or authorized.

However, a PIN or other type of password offers limited security of the sensitive or confidential information stored on the server. For example, the database of the server remains susceptible to loss or theft. Additionally, users generally limit the length of a password or PIN to familiar dates or terms and to a quantity of digits that is easy to memorize and remember. Accordingly, passwords or PINs may be easy to crack or obtain, for example, by utilizing various iterative software programs.

### SUMMARY OF THE INVENTION

In accordance with one embodiment of the present invention, a method for secure data transmission comprises receiving an identifier from a user and automatically combining the identifier with padding data to form a padded identifier. The padded identifier is associated with accessing data at a recipient device. The method also comprises transmitting the padded identifier to the recipient device.

In accordance with another embodiment of the present invention, a system for secure data transmission comprises a memory accessible by a processor, an entry application stored in the memory and executable by the processor, and a padding application stored in the memory. The entry application is adapted to receive an identifier from a user. The padding application is adapted to automatically combine the identifier with padding data to form a padded identifier. The padded identifier is associated with accessing data at a recipient device.

In accordance with another embodiment of the present invention, a method for secure data transmission comprises receiving at a recipient device unencrypted data and an identifier on an initial transaction. The method also comprises encrypting the unencrypted data using the identifier to form encrypted data. The method also comprises discarding the unencrypted data and the identifier. The method further comprises decrypting at the recipient device the encrypted data in response to receipt of the identifier on a subsequent transaction.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating a system for secure data transmission in accordance with an embodiment of the present invention;

FIG. 2 is a flow chart illustrating a method for secure data transmission in accordance with an embodiment of the present invention; and

FIG. 3 is a flow chart illustrating a method for secure data transmission in accordance with another embodiment of the present invention.

### DETAILED DESCRIPTION OF THE DRAWINGS

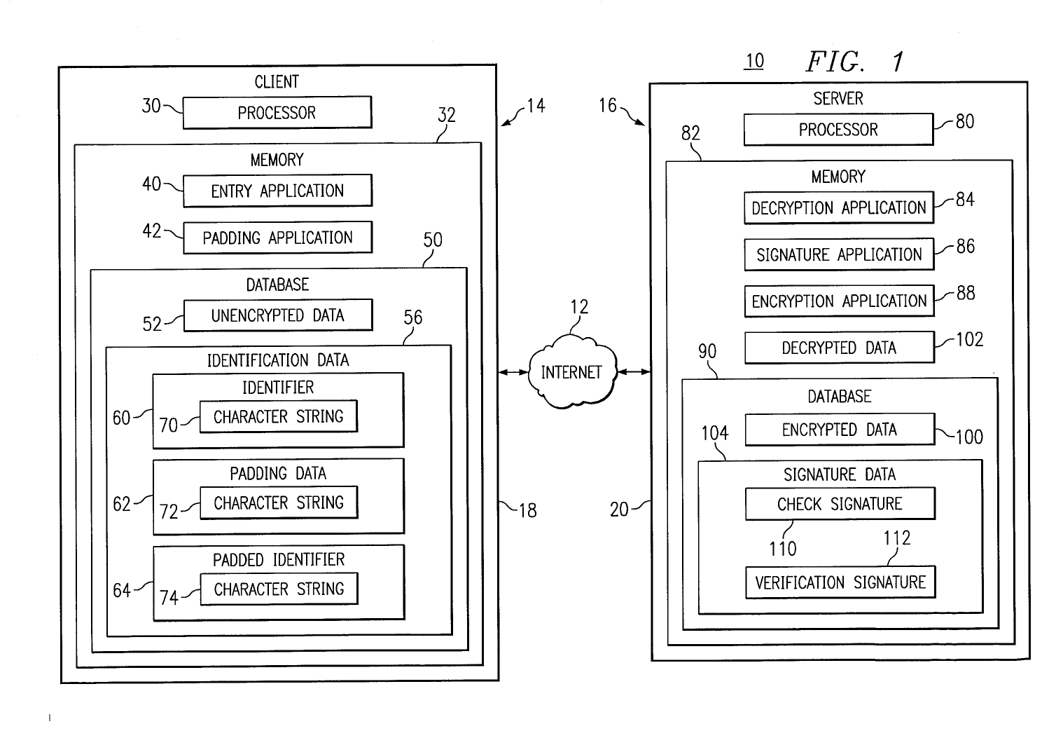

The preferred embodiments of the present invention and the advantages thereof are best understood by referring to FIGS. 1 through 3 of the drawings, like numerals being used for like and corresponding parts of the various drawings.

Briefly, data associated with a user, such as financial, personal, or other types of sensitive or confidential information, is remotely stored in an encrypted format. A password or PIN is provided by a user or owner of the information to authorize the use of the information or access to the information. The password or PIN may be automatically padded with additional data or information to increase the security level associated with the password or PIN. The padded password or PIN is then used as an encryption key to encrypt the remotely stored information. Thus, when the user desires to access, use, or authorize the access or use of the information, the padded password or PIN is transmitted to the remote storage device for decryption of the data. The padding of the password or PIN is generally invisible to the user, thereby providing no additional burden to the user.

FIG. 1 is a diagram illustrating a system 10 for secure data transmission in accordance with an embodiment of the present invention. In the illustrated embodiment, information or data is communicated via the Internet 12 between a sending device 14 and a recipient device 16. For example, in the illustrated embodiment, sending device 14 and recipient device 16 comprise a client 18 communicating with a server 20, respectively, via the Internet 12; however, it should be understood that other communication mediums, such as, but not limited to, local area networks or wide area networks, may also be used. Additionally, it should be understood that sending device 14 may represent a variety of different components now known or later developed such as, but not limited to, an ATM, a desktop computer, a card reading device associated with a variety of consumer transactions, or a personal digital assistant such that sending device 14 comprises the functionality as set forth herein. Sending device 14 and recipient device 16 may also comprise like or similar components. For example, sending device 14 and recipient device 16 may both comprise a server.

In the illustrated embodiment, client 18 comprises a processor 30 coupled to a memory 32. The present invention also encompasses computer software that may be stored in memory 32 and executed by processor 30. In this embodiment, client 18 comprises an entry application 40 and a padding application 42, which are computer software programs. In FIG. 1, entry application 40 and padding application 42 are illustrated as being stored in memory 32, where they can be executed by processor 30. Briefly, entry application 40 is used to receive information or data from a user of system 10. Padding application 42 is used to enhance the security level associated with a password, PIN or other identifier associated with securing the data from unauthorized access or use.

The client 18 illustrated in FIG. 1 also comprises a database 50. In the illustrated embodiment, database 50 comprises unencrypted data 52 and identification data 56. Unencrypted data 52 comprises information received by client 18 from a user of client 18. For example, unencrypted data 52 may comprise information associated with financial accounts, such as, but not limited to, information received by scanning an ATM card or a credit card. The user may also manually enter unencrypted data 52 into client 18 by, for example, a keyboard or other type of input device.

Identification data 56 comprises information associated with identifying a particular user and/or particular data 52 associated with the user or authorizing the use or access to data 52. For example, in the illustrated embodiment, identification data 56 comprises an identifier 60, padding data 62, and a padded identifier 64. Identifier 60 comprises information provided by a user of client 18 to verify ownership or authorize access to data 52 such as, but not limited to, a password or a PIN. For example, in the illustrated embodiment, identifier 60 comprises a character string 70, which may comprise a combination of alphanumeric characters and/or symbols of a particular length or having a particular quantity of digits.

Padding data 62 comprises information generated by padding application 42 and combined or merged with identifier 60 to further prevent the unauthorized use of data 52 or access to data 52. In accordance with the present invention, padding application 42 automatically generates padding data 62 and combines padding data 62 with identifier 60. The resulting combination of padding data 62 with identifier 60 may be stored in database 50 as a padded identifier 64.

In operation, padding application 42 reviews identifier 60 and automatically determines whether additional data should be combined with identifier 60 to increase the security level associated with identifier 60. For example, in the illustrated embodiment, identifier 60 comprises character string 70. As briefly described above, character string 70 may comprise a combination of alphanumeric digits and/or symbols of a particular length or having a particular quantity of digits. If the length of character string 70 is relatively short, or less than a predetermined quantity of digits, padding application 42 automatically generates padding data 62 for combining or merging with identifier 60. For example, in the illustrated embodiment, padding data 62 also comprises a character string 72, which may comprise a combination of alphanumeric digits and/or symbols of a particular length or quantity of digits such that the combination of character strings 70 and 72 extends a predetermined quantity of digits. Padding application 42 combines character strings 70 and 72 to form padded identifier 64 which, in this example, also comprises a character string 74 having the desired quantity of digits or length. Padding data 62 may be combined with identifier 60 in a variety of methods. For example, padding data 62 may be added after identifier 60 such that padding data 62 follows an end of character string 70, placed before identifier 60 such that padding data 62 precedes the beginning of character string 70, or intermingled with the characters of identifier 60 such that padding data 62 is inserted into one or more intermediate portions of character string 70.

In the illustrated embodiment, padding data 62 is stored in database 50 upon an initial transaction corresponding to the use of identifier 60 such that padding data 62 may be retrieved for each subsequent transaction and combined with identifier 60. In the illustrated embodiment, generating and storing padding data 62, as well as the combining of padding data 62 with identifier 60, is invisible to the user, thereby providing no additional burden on the user while increasing the security level associated with identifier 60 and data 52. In the case of an ATM card, bank card, credit card, or other card-associated application, the padding data 62 may be stored on the corresponding card.

In the illustrated embodiment, server 20 also comprises a processor 80 coupled to a memory 82. Embodiments of the present invention may comprise computer software that may be stored in memory 82 and executed by processor 80. In this embodiment, server 20 comprises a decryption application 84, a signature application 86, and an encryption application 88, which are computer software programs. In FIG. 1, decryption application 84, signature application 86, and encryption application 88 are illustrated as being stored in memory 82, where they can be executed by processor 80. Briefly, decryption application 84 and signature application 86 are used to decrypt and verify or authenticate the data associated with a particular user of system 10. Encryption application 88 is used to encrypt data 52.

Server 20 also comprises a database 90 accessible by processor 80. In the illustrated embodiment, database 90 comprises encrypted data 100 and signature data 104. Encrypted data 100 comprises information associated with the user stored to server 20 in an encrypted format. For example, the user of system 10 may transmit to server 20 via the Internet 12 or some other communication medium data 52 and either identifier 60 or padded identifier 64. Encryption application 88 encrypts data 52 using either the corresponding transmitted identifier 60 or padded identifier 64 and stores as encrypted data 100 in database 90. Data 52 may also be encrypted and stored in database 90 by a network administrator. For example, in an ATM or bank card application, encrypted data 100 associated with the ATM or bank card may be stored in database 90 by a network administrator prior to an initial use the ATM or bank card by a user. Accordingly, either identifier 60 or padded identifier 64 used to encrypt data 100 may be encoded or stored on the card.

Decryption application 84 is used to decrypt data 100. For example, when the user desires to access or authorize the use of data 100, the user transmits either the corresponding identifier 60 or padded identifier 64 used to encrypt data 52 from client 18 to server 20. Decryption application 84 decrypts data 100 using the corresponding identifier 60 or padded identifier 64 and temporarily stores the decrypted information as decrypted data 102 in memory 82. After the intended use or access of decrypted data 102 is complete, decrypted data 102 is deleted or removed from memory 82.

To further authenticate and/or verify proper decryption of data 100, signature application 86 generates a check signature 110, which is stored in database 90, based on decrypted data 102. Check signature 110 is verified against a verification signature 112 stored in database 90. Verification signature 112 is generated based on data 52. For example, as briefly described above, server 20 may receive data 52 from client 18 to accommodate encryption and storage of data 52 as data 100. Signature application 86 may be used to generate verification signature 112 using data 52. Alternatively, verification signature 112 may also be retrieved from a remote storage area or device. Verification signature 112 may also be stored to server 20 by a network administrator, for example, in an ATM or bank card application. If signature 110 does not match signature 112, processor 80 may be configured to generate an alert or alarm to either a user or network administrator of system 10 indicating improper authentication or the unsuccessful attempt to access or use encrypted data 100.

In operation, entry application 40 comprises an interface for the user to access client 18. For example, entry application 40 provides an interface for receiving data 52 from the user. Entry application 40 may also be adapted to request identifier 60 from the user. For example, in a bank or ATM card application, after receiving data 52 from the user, such as reading the bank or ATM card, the user may be prompted to enter identifier 60. In a web-based application, entry application 40 may comprise a plurality of fields for accepting data 52 and identifier 60 from the user.

In a credit or ATM card application, the card issuer may generate and store data 100 in database 90 as an initial transaction corresponding to encryption of data 52. In this card-based example, identifier 60 and padding data 62 may be preassigned by the issuer and encoded or stored on the card. Thus, for subsequent transactions corresponding to data 52, the user inputs identifier 60 into entry application 40. If padding data 62 has been encoded onto the card and was used to encrypt data 52, padding data 62 is retrieved and automatically combined with identifier 60 input by the user. The resulting padded identifier 64 is then transmitted to server 20. If padding data 62 was not used to encrypt data 52, identifier 60 input by the user is transmitted to server 20.

In a web-based application, such as a shopping or other type of web page, entry application 40 may display various input fields for receiving data 52 and identifier 60 from the user. As described above, if the security level associated with identifier 60 does not predetermined minimum security levels, padding data 62 may be automatically generated and combined with identifier 60 to form padded identifier 64. As part of an initial transaction corresponding to the encryption of data 52, data 52 and either identifier 60 or, if applicable, padded identifier 64 is transmitted top server 20 where encryption application 88 encrypts and stores as data 100. As part of a subsequent check-out or other transaction, the corresponding identifier 60 or padded identifier 64 is transmitted to server 20 to provide for decryption of data 100 at server 20.

The user may also have the option of selecting identifier 60 or changing identifier 60 which may have been pre-assigned, such as in a bank or ATM card application. In this example, the initial transaction corresponding to data 52 would be to transmit data 52 along with either the new identifier 60 or, as applicable, padded identifier 64, to server 20 where encryption application 88 encrypts data 52 and stores or replaces data 100. On subsequent transactions, identifier 60 selected by the user is input to entry application 40. As described above, identifier 60 is then transmitted to server 20. If padding data 62 was combined with identifier 60, padded identifier 64 is then transmitted to server 20.

Thus, after data 52 is stored at server 20 in an encrypted format, only identifier 60 is input by the user at client 18. If data 100 was encrypted using padded identifier 64, padding application retrieves padding data 62 and combines padding data 62 with identifier 60 input by the user. The padded identifier 64 is then transmitted to server 20 on subsequent transactions to accommodate decryption of data 100. If data 100 was encrypted using identifier 60, then identifier 60 is transmitted on subsequent transactions. Accordingly, because data 100 is stored at server 20 in an encrypted format, theft or unauthorized access or use of data 52 is substantially reduced or eliminated.

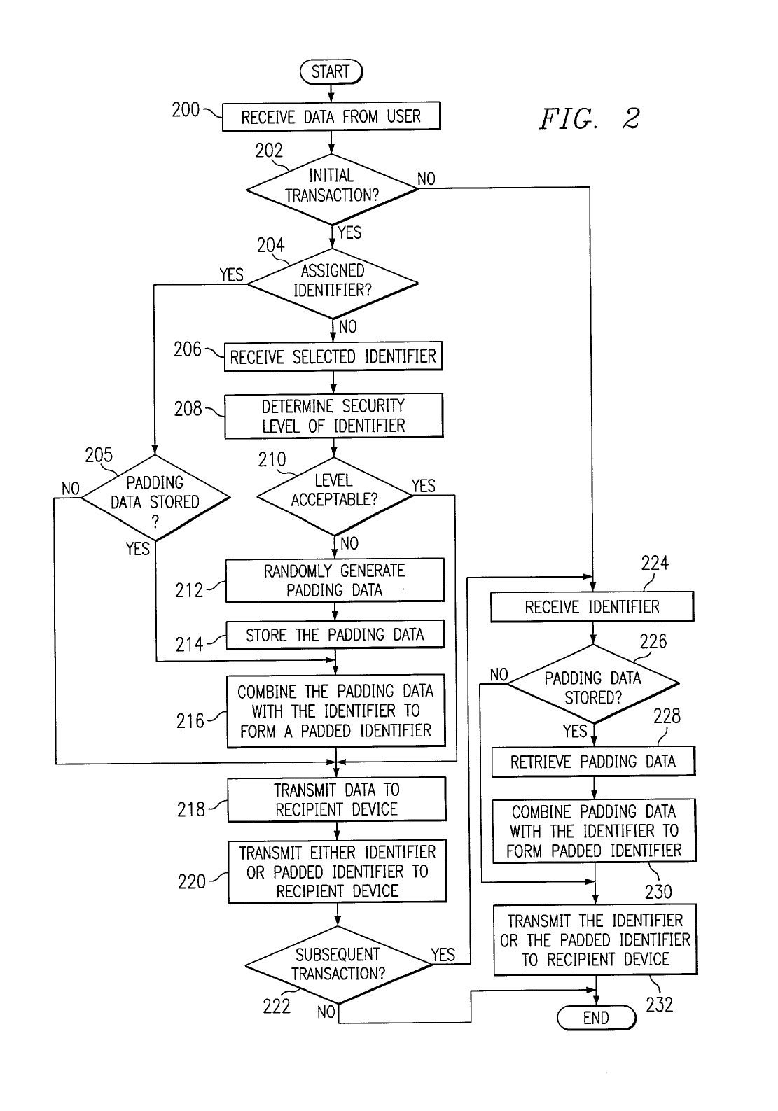

FIG. 2 is a flowchart illustrating a method for secure data transmission in accordance with an embodiment of the present invention. The method begins at step 200, where data 52 is received from a user at client 18. As described above, data 52 may be received from the user in a variety of ways, such as, but not limited to, reading data 52 from a data storage medium, such as an ATM, bank, or credit card, or receiving data 52 via a web page from a user utilizing an input device, such as a keyboard.

At step 202, a determination is made whether the current transaction is an initial transaction corresponding to encryption of data 52. For example, as used herein, the initial transaction may be defined as a transaction in which sensitive or confidential information associated with the user is encrypted and stored at recipient device 16. If the current transaction is an initial transaction, the method proceeds from step 202 to decisional step 204, where a determination is made whether an identifier 60 associated with data 52 has been previously assigned. For example, in an ATM, bank, or credit card application, a unique identifier, such as a PIN, may be pre-assigned corresponding to the card. If identifier 60 has not been previously assigned, the method proceeds from step 204 to decisional step 205, where a determination is made whether padding data 62 has been previously generated and stored corresponding to identifier 60. For example, in an ATM, bank, or credit card application, padding data 62 may be encoded or stored on the card such that the encoded padding data 62 may be automatically retrieved and combined with identifier 60 to form padded identifier 64. If padding data 62 has been previously generated and stored, the method proceeds from step 205 to step 216. If padding data 62 has not been previously generated and stored, the method proceeds from step 205 to step 218.

If identifier 60 has not been assigned at step 204, the method proceeds from step 204 to step 206, where client 18 receives an identifier 60 selected by the user. At step 208, a determination is made as to the security level associated with identifier 60. For example, a length of an alphanumeric character string or other method may be used to determine the security level associated with identifier 60. At decisional step 210, a determination is made as to the acceptability of the security level associated with identifier 60. For example, the security level associated with identifier 60 may be compared to predetermined minimum security level requirements. If the security level associated with identifier 60 does not meet the minimum requirements, the method proceeds from step 210 to step 212, where padding application 42 randomly generates padding data 62. At step 214, the generated padding data 62 is stored in database 50. At step 216, padding data 62 is combined with identifier 60 to form padded identifier 64. If the security level associated with identifier 60 is acceptable at step 210, the method proceeds from step 210 to step 218.

At step 218, data 52 is transmitted to recipient device 16. At step 220, either identifier 60 or padded identifier 64 is transmitted to recipient device 16 to accommodate encryption of data 52 at recipient device 16. For example, if the security level associated with identifier 60 is determined at step 210 to be acceptable, identifier 60 is used as an encryption key. If the security level of identifier 60 is found to be unacceptable, padding data 62 is generated and combined with identifier 60 such that padded identifier 64 is used as an encryption key.

At decisional step 222, a determination is made whether a subsequent transaction is to be performed. As used herein, a subsequent transaction may be a transaction occurring after data 52 has been encrypted and stored at recipient device 16. If a subsequent transaction is to be performed, the method proceeds from step 222 to step 224. Additionally, if at step 202 a determination is made that the current transaction is not the initial transaction, the method proceeds from step 202 to step 224. For example, in the case of an ATM, bank, or credit card, the user's first use of the card may be considered a subsequent transaction, and not an initial transaction, because the card issuer may have previously stored data 54 in an encrypted format on server 20 prior to the user's first use of the corresponding card.

At step 224, identifier 60 is received from the user. At decisional step 226, a determination is made whether padding data 62 was previously generated and stored. For example, padding data 62 may be stored on an ATM or bank card or stored at client 18. If padding data 62 was previously generated and stored, the method proceeds from step 226 to step 228, where padding data 62 is retrieved. At step 230, padding data 62 is combined with identifier 60 to form padded identifier 64. If padding data 62 was not previously generated and stored at step 226, the method proceeds from step 226 to step 232. At step 232, either the corresponding identifier 60 or padded identifier 64 is transmitted to recipient device 16.

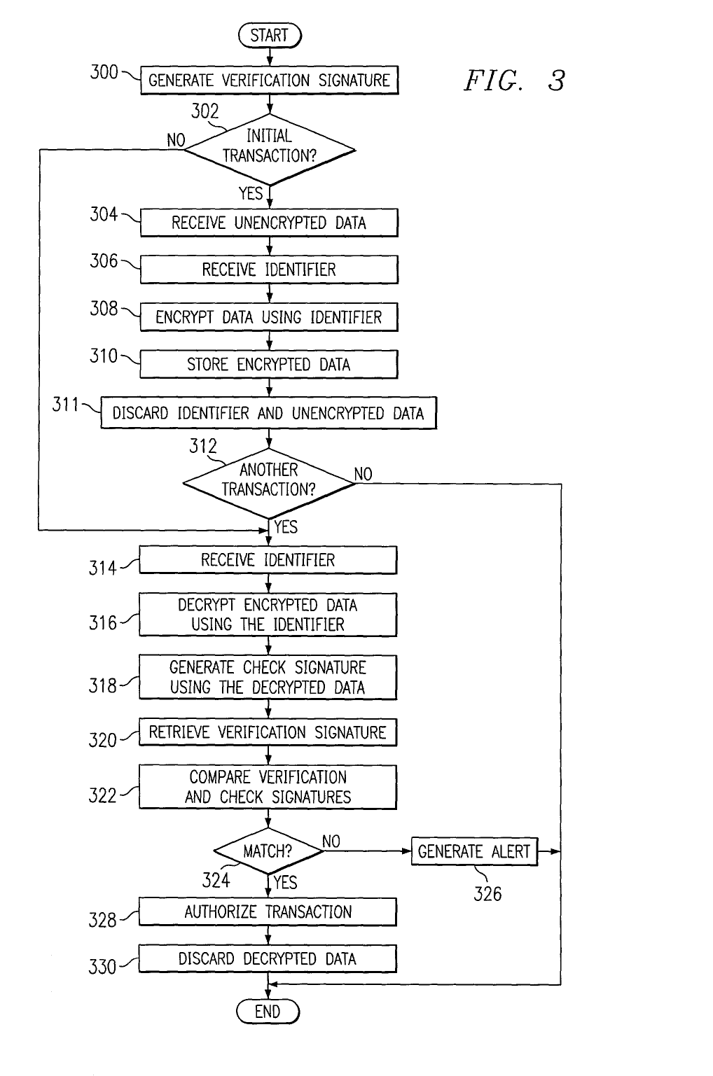

FIG. 3 is a flowchart illustrating a method for secured data transmission in accordance with another embodiment of the present invention. The method begins at step 300, where recipient device 16, such as server 20, generates and stores verification signature 112. For example, as briefly described above, verification signature 112 may be stored in database 90 by a network administrator or may be generated by signature application 86 using data 52 and either identifier 60 or padded identifier 64 received from client 18 via the Internet 12. At decisional step 302, a determination is made whether the current transaction is an initial transaction corresponding to encryption of data 52. If the current transaction is the initial transaction, the method proceeds from step 302 to step 304, where server 20 receives data 54.

At step 306, server 20 receives identifier 60 from client 18. In this example, the security level associated with identifier 60 is to be considered as having exceeded the minimum predetermined security requirements and, therefore, generation of padding data 62 and padded identifier 64 was not required; however, it should be understood that in the method illustrated in this FIG. 3, identifier 60 may be replaced with padded identifier 64 if security level requirements associated with identifier 60 required the generation of padding data 62 and padded identifier 64. At step 308, encryption application 88 encrypts data 52 using identifier 60 as an encryption key. At step 310, encrypted data 100 is stored in database 90. At step 311, the unencrypted data 52 and identifier 60 are discarded or removed from memory 82 such that only encrypted data 100 remains in memory 82.

At decisional step 312, a determination is made whether a subsequent transaction is to be performed. If a subsequent transaction is to be performed, the method proceeds from step 312 to step 314. Additionally, if the current transaction is determined not to be the initial transaction at step 302, the method proceeds from step 302 to step 314. At step 314, recipient device 16, such as server 20, receives identifier 60 from client 18. Additionally, as briefly described above, padded identifier 64 may also be used in lieu of identifier 60 by client 18 if corresponding security levels associated with identifier 60 are determined to be unacceptable. At step 316, decryption application 84 decrypts encrypted data 100 using identifier 60, or padded identifier 64 as applicable, as a decryption key.

At step 318, signature application 86 generates check signature 110 using decrypted data 102. At step 320, signature application 86 retrieves verification signature 112 from database 90. At step 322, signature application 86 compares check signature 110 with verification signature 112 to verify proper decryption of encrypted data 100. At decisional step 324, a determination is made whether check signature 110 matches verification signature 112. If signatures 110 and 112 do not match, the method proceeds from step 324 to step 326, where an alert may be generated indicating to the user or a network administrator an unsuccessful and/or unauthorized access to encrypted data 100. If signatures 110 and 112 do match, the method proceeds from step 324 to step 328, where authorization and/or access for the transaction is granted. At step 330, decrypted data 102 is discarded or removed from memory 82 such that only encrypted data 100 remains in memory 82.

What is claimed is:

1. A method for secure data transmission, comprising:
receiving an identifier from a user;
automatically combining the identifier with padding data to form a padded identifier, the padded identifier associated with accessing data at a recipient device; and
transmitting the padded identifier to the recipient device.

2. The method of claim 1, further comprising randomly generating the padding data.

3. The method of claim 1, further comprising storing the padding data on an initial transaction.

4. The method of claim 3, wherein automatically combining further comprises automatically combining the stored padding data with the identifier on a subsequent transaction.

5. The method of claim 1, wherein the identifier comprises a character string.

6. The method of claim 5, wherein automatically combining comprises adding the padding data to an end of the character string.

7. The method of claim 5, wherein automatically combining comprises inserting the padding data into an intermediate portion of the character string.

8. The method of claim 5, wherein the padding data comprises a character string.

9. The method of claim 8, wherein automatically combining comprises combining the identifier character string and the padding data character string to extend a length of the identifier character string to a desired length.

10.. The method of claim 1, wherein the identifier and the padding data each comprise a character string, and further comprising:
automatically determining a length of the identifier character string; and
automatically generating the padding data character string having a length such that a combination of the identifier and padding data character strings extends the length of the identifier character string to a desired length.

11. The method of claim 1, further comprising determining whether the padding data was previously generated and stored and, if so, retrieving the stored padding data.

12. A system for secure data transmission, comprising:
a memory accessible by a processor;
an entry application stored in the memory and executable by the processor, the entry application adapted to receive an identifier from a user; and
a padding application stored in the memory, the padding application adapted to automatically combine the identifier with padding data to form a padded identifier, the padded identifier associated with accessing data at a recipient device.

13. The system of claim 12, wherein the padding application is further adapted to generate the padding data based on a security level associated with the identifier.

14. The system of claim 12, wherein the padding application is further adapted to randomly generate the padding data based on a security level associated with the identifier.

15. The system of claim 12, wherein the padding application is adapted to store the padding data on an initial transaction.

16. The system of claim 15, wherein the padding application is further adapted to automatically retrieve and combine the stored padding data with the identifier on a subsequent transaction.

17. The system of claim 12, wherein the identifier comprises a character string.

18. The system of 17, wherein the padding application is adapted to insert the padding data into an intermediate portion of the character string.

19. The system of claim 17, wherein the padding data comprises a character string.

20. The system of claim 18, wherein the padding application is adapted to generate the padding data character string having a length such that a combination of the identifier and padding data character strings extends the length of the identifier character string to a desired length.

21. The system of claim 11, wherein the padding application is further adapted to determine whether the padding data was previously stored and, if so, retrieve the stored padding data.

22. A method for secure data transmission, comprising:
receiving an identifier from a user;
determining a security level associated with the identifier; and
automatically combining padding data with the identifier to form a padded identifier if the security level does not meet predetermined security requirements, the padded identifier associated with accessing data at a recipient device.

23. The method of claim 22, further comprising automatically generating the padding data if the security level does not meet the predetermined security requirements.

24. The method of claim 22, wherein the identifier and the padding data each comprise a character string.

25. The method of claim 24, further comprising generating the padding data character string having a length such that a combination of the identifier and padding data character strings extends the length of the identifier character string to a desired length.

26. The method of claim 22, wherein the identifier comprises a character string.

27. The method of claim 26, wherein automatically combining comprises adding the padding data to an end of the character string.

28. The method of claim 26, wherein automatically combining comprises inserting the padding data into an intermediate portion of the character string.

29. The method of claim 22, further comprising transmitting the padded identifier to the recipient device.

30. The method of claim 22, wherein determining comprises determining a length of the identifier.

31. The method of claim 30, further comprising generating the padding data to increase the length of the identifier to a desired length.

32. A method for secure data transmission, comprising:
receiving at a recipient device unencrypted data on an initial transaction;
receiving at the recipient device an identifier on the initial transaction;
encrypting the unencrypted data using the identifier to form encrypted data;
discarding the unencrypted data and the identifier; and
decrypting at the recipient device the encrypted data in response to receipt of the identifier on a subsequent transaction.

33. The method of claim 32, further comprising verifying the decrypted data using a signature stored at the recipient device.

34. The method of claim 32, further comprising:
generating a first signature at the recipient device using the decrypted data; and
comparing the first signature with a second signature to verify proper decryption of the encrypted data, the second signature generated using the unencrypted data.

35. The method of claim 32, wherein receiving an identifier on an initial transaction comprises receiving a padded identifier, and wherein encrypting comprises encrypting the data using the padded identifier to form encrypted data.

36. The method of claim 35, wherein receiving the identifier on a subsequent transaction comprises receiving the padded identifier on a subsequent transaction.

37. The method of claim 32, further comprising generating a signature at the recipient device on the initial transaction using the unencrypted data.

38. The method of claim 37, further comprising comparing the signature generated on the initial transaction with another signature generated on a subsequent transaction using the decrypted data.

39. The method of claim 32, further comprising discarding the decrypted data after completion of each subsequent transaction.
